(19) United States
(12) Patent Application Publication
(10) Pub. No.: US 2005/0216468 A1
(43) Pub. Date: Sep. 29, 2005

(54) Data retrieval system, data retrieval method and data retrieval program

(75) Inventors: Asuka Fujiwara, Tokyo (JP); Noriyo Ohkatu, Osaka (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/090,873

(22) Filed: Mar. 28, 2005

(30) Foreign Application Priority Data
Mar. 29, 2004 (JP) 2004-096269

(51) Int. Cl. G06F 7/00

(52) U.S. Cl. 707/9

(57) ABSTRACT

In a data retrieval system which retrieves data of a data base according to a search key entered by a user by means of a search engine to return a retrieval result to the user, an access right attribute value indicative of a range of an access right of the user is set to the data of the data base, and the search key to be registered at the search engine is designed to enable designation of the access right attribute value.

### BACKGROUNDS OF THE INVENTION

1. Field of the Invention

The present invention relates to a data retrieval system, and more particularly, a data retrieval system enabling speed-up of processing for examining a right to access a retrieval result.

2. Description of the Related Art

In conventional data retrieval systems in document management systems, when a user inputs a predetermined retrieval condition to a terminal, data is retrieved by a search engine based on the input retrieval condition and a retrieval result is returned to the user.

In such a data retrieval system as described above, examining a right to access a retrieval result obtained by a search engine (whether a user has authorization to refer to or update data) is essential. Examination of an access right, however, is in general made at a low speed for search performance of a search engine, so that performance of the retrieval system might be degraded due to this processing.

Among conventional data retrieval systems are, for example, the picture retrieval device disclosed in Japanese Patent Laying-Open (Kokai) No. 2000-99535 (Literature 1) and the document management device disclosed in Japanese Patent Laying-Open (Kokai) No. (Heisei) 10-232878 (Literature 2).

In the picture retrieval device recited in Literature 1, document picture data with an access right set is generated from original document picture data and managed to retrieve document picture data which includes an input retrieval condition and satisfies a security level of an operator, compare the access right applied to the retrieved document picture data and an access right of the operator and output a retrieval result based on the comparison result.

In the document management device recited in Literature 2, which manages an access right according to a group to which a user belongs, an access right table in which information about whether a user belonging to a group is allowed to access a document or not is registered is generated and used to determine whether a person who makes retrieval has a document access right or not.

The above-described conventional data retrieval systems have the following problems.

First, in general, as compared with retrieval processing by a search engine, processing of examining an access right takes more time to degrade performance of a retrieval system due to this processing.

Although it is possible to include access right examination processing as a retrieval condition in order to avoid the problem, in such a case, it will be necessary to describe every access right information which is to be assigned to each data into data of a data base, resulting in making data arrangement of the data base complicated, which will be followed by complication of a retrieval expression accordingly.

### SUMMARY OF THE INVENTION

An object of the present invention is to provide a data retrieval system which realizes improvement of retrieval performance by speeding up processing for examining a right to access a retrieval result in data retrieval.

Another object of the present invention is to provide a data retrieval system which realizes speed-up of processing for examining an access right without largely changing data arrangement of a data base.

According to the first aspect of the invention, a data retrieval system which retrieves data of a data base according to a search key entered by a user by means of a search engine to return a retrieval result to the user, wherein an access right attribute value indicative of a range of an access right of the user is set to data of the data base, and the search key to be registered at the search engine is designed to enable designation of the access right attribute value.

In the preferred construction, at the time of registering data at the data base, an access right attribute value indicative of a range of an access right of the user is set to the data and the access right attribute value is registered at the search key to be registered at the search engine, and the search key is enabled to designate the access right attribute value at the time of retrieval of the data base.

In another preferred construction, to the access right attribute value, a value is set for each user having the access right.

In another preferred construction, at the time of registering data at the data base, an access right attribute value indicative of a range of an access right of the user is set to the data and the access right attribute value is registered at the search key to be registered at the search engine, the search key is enabled to designate the access right attribute value at the time of retrieval of the data base, and to the access right attribute value, a value is set for each user having the access right.

In another preferred construction, to the access right attribute value, a value is set for each user having the access right, and out of the access rights to which the data is applied, two of the access right attribute value which is the smallest and the access right attribute value which is the largest are set to the data of the data base.

In another preferred construction, at the time of registering data at the data base, an access right attribute value indicative of a range of an access right of the user is set to the data and the access right attribute value is registered at the search key to be registered at the search engine, the search key is enabled to designate the access right attribute value at the time of retrieval of the data base, to the access right attribute value, a value is set for each user having the access right, and out of the access rights to which the data is applied, two of the access right attribute value which is the smallest and the access right attribute value which is the largest are set to the data of the data base.

In another preferred construction, to each kind of the access right, an access right attribute value indicative of a range of the access right is set.

In another preferred construction, at the time of registering data at the data base, an access right attribute value indicative of a range of an access right of the user is set to the data and the access right attribute value is registered at the search key to be registered at the search engine, the search key is enabled to designate the access right attribute value at the time of retrieval of the data base, and to each kind of the access right, an access right attribute value indicative of a range of the access right is set.

In another preferred construction, the access right includes a reference right which allows reference to data and an update right which allows update of data and to each of the reference right and the update right, an access right attribute value indicative of a range of the access right is set.

In another preferred construction, the access right attribute value is set with respect to an access right of the user and an access right of an office to which the user belongs such that the access right attribute value corresponding to the access right of the office is smaller than the access right attribute value corresponding to the access right of the user.

In another preferred construction, at the time of registering data at the data base, an access right attribute value indicative of a range of an access right of the user is set to the data and the access right attribute value is registered at the search key to be registered at the search engine, the search key is enabled to designate the access right attribute value at the time of retrieval of the data base, and the access right attribute value is set with respect to an access right of the user and an access right of an office to which the user belongs such that the access right attribute value corresponding to the access right of the office is smaller than the access right attribute value corresponding to the access right of the user.

According to another aspect of the invention, a data retrieval method in a data retrieval system of retrieving data of a data base according to a search key entered by a user by means of a search engine to return a retrieval result to the user, comprising the steps of setting an access right attribute value indicative of a range of an access right of the user to data of the data base, and designating the access right attribute value to the search key to be registered at the search engine to make retrieval.

In the preferred construction, at the time of registering data at the data base, an access right attribute value indicative of a range of an access right of the user is set to the data and the access right attribute value is registered at the search key to be registered at the search engine, and at the time of retrieval of the data base, the access right attribute value is designated to the search key to make retrieval.

In another preferred construction, as the access right attribute value, a value is set for each user having the access right.

In another preferred construction, at the time of registering data at the data base, an access right attribute value indicative of a range of an access right of the user is set to the data and the access right attribute value is registered at the search key to be registered at the search engine, as the access right attribute value, a value is set for each user having the access right, and at the time of retrieval of the data base, the access right attribute value is designated to the search key to make retrieval.

In another preferred construction, out of the access right to which the data is applied, two of the access right attribute value which is the smallest and the access right attribute value which is the largest are set to the data of the data base.

In another preferred construction, to each kind of the access right, an access right attribute value indicative of a range of the access right is set.

In another preferred construction, the access right includes a reference right which allows reference to data and an update right which allows update of data and to each of the reference right and the update right, an access right attribute value indicative of a range of the access right is set.

In another preferred construction, the access right attribute value is set with respect to an access right of the user and an access right of an office to which the user belongs such that the access right attribute value corresponding to the access right of the office is smaller than the access right attribute value corresponding to the access right of the user.

According to another aspect of the invention, a data retrieval program in a data retrieval system which retrieves data of a data base according to a search key entered by a user by means of a search engine to return a retrieval result to the user, comprising the functions of setting an access right attribute value indicative of a range of an access right of the user to data of the data base, and designating the access right attribute value to the search key to be registered at the search engine to make retrieval.

In the preferred construction, at the time of registering data at the data base, an access right attribute value indicative of a range of an access right of the user is set to the data and the access right attribute value is registered at the search key to be registered at the search engine, and at the time of retrieval of the data base, the access right attribute value is designated to the search key to make retrieval.

In another preferred construction, as the access right attribute value, a value is set for each user having the access right.

In another preferred construction, at the time of registering data at the data base, an access right attribute value indicative of a range of an access right of the user is set to the data and the access right attribute value is registered at the search key to be registered at the search engine,
as the access right attribute value, a value is set for each user having the access right, and
at the time of retrieval of the data base, the access right attribute value is designated to the search key to make retrieval.

In another preferred construction, out of the access right to which the data is applied, two of the access right attribute value which is the smallest and the access right attribute value which is the largest are set to the data of the data base.

In another preferred construction, to each kind of the access right, an access right attribute value indicative of a range of the access right is set.

In another preferred construction, the access right includes a reference right which allows reference to data and an update right which allows update of data and to each of the reference right and the update right, an access right attribute value indicative of a range of the access right is set.

In another preferred construction, the access right attribute value is set with respect to an access right of the user and an access right of an office to which the user belongs such that the access right attribute value corresponding to the access right of the office is smaller than the access right attribute value corresponding to the access right of the user.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a diagram showing an entire structure of a retrieval system according to a first embodiment of the present invention;

FIG. 2 is a diagram showing an example of arrangement of data to be registered at the retrieval system according to the first embodiment of the present invention;

FIG. 3 is a diagram showing an example of data in a data base in the retrieval system according to the first embodiment of the present invention;

FIG. 4 is a diagram showing data with values which access right information attributes can attain and users included in access right information aligned on a number line;

FIG. 5 is a diagram showing data with values which access right information attributes can attain and users included in access right information aligned on a number line;

FIG. 6 is a diagram showing an example of data in the data base in the retrieval system according to the first embodiment of the present invention;

FIG. 7 is a diagram showing data with values which access right information attributes can attain and users included in access right information aligned on a number line;

FIG. 8 is a flow chart for use in explaining operation in retrieval of the retrieval system according to the first embodiment of the present invention;

FIG. 9 is a diagram showing an example of arrangement of data to be registered at a retrieval system according to a second embodiment of the present invention;

FIG. 10 is a diagram showing an example of data in a data base in the retrieval system according to the second embodiment of the present invention;

FIG. 11 is a diagram showing an example of data in the data base in the retrieval system according to the second embodiment of the present invention;

FIG. 12 is a diagram showing data with values which access right information attributes can attain and users included in access right information which allows reference aligned on the abscissa and values which access right information attributes can attain and users included in access right information (update right) which allows update aligned on the ordinate;

FIG. 13 is a diagram showing an example of arrangement of data to be registered at a retrieval system according to a third embodiment of the present invention;

FIG. 14 is a diagram showing an example of data in a data base in the retrieval system according to the third embodiment of the present invention;

FIG. 15 is a diagram showing data with values which access right information attributes can attain and users included in access right information aligned on a number line;

FIG. 16 is a diagram showing data with values which access right information attributes can attain and users included in access right information aligned on a number line;

FIG. 17 is a diagram showing an example of data in the data base in the retrieval system according to the third embodiment of the present invention;

FIG. 18 is a diagram showing a relationship between each organization and a user belonging to the organization in the third embodiment of the present invention;

FIG. 19 is a diagram showing data with values which access right information attributes can attain and users included in access right information aligned on a number line.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

### EMBODIMENT 1

In the following, a first embodiment of the present invention will be described in detail with reference to the drawings.

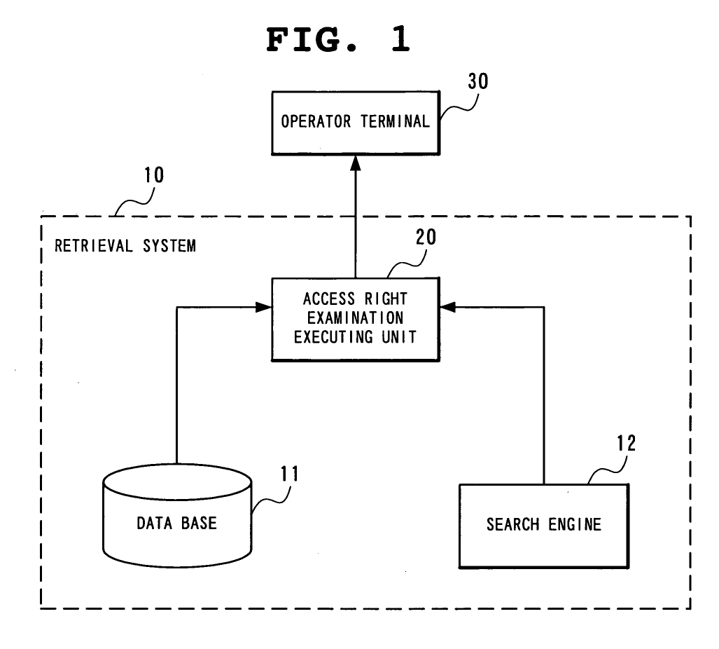

FIG. 1 is a block diagram showing outlines of a retrieval system according to the first embodiment of the present invention. A retrieval system 10 according to the first embodiment includes a data base 11 in which data is registered together with an attribute such as its name and access right information, a search engine 12 which executes data retrieval from the data base 11 and an access right examination executing unit 20 as a unit which examines an access right, with an operator terminal 30 of a user who uses the retrieval system 10 connected to the access right examination executing unit 20 through a network or the like.

In FIG. 1, when the user operates the operator terminal 30 to make retrieval from the retrieval system 10, the access right examination executing unit 20 realizes a function of returning only a result that is allowed to return to the user (data with an access right set which indicates that reference by the user is allowed) out of results obtained from the search engine 12.

The search engine 11 and the access right examination executing unit 20 are realized as software by executing a program for making retrieval and a program for executing access right examination on a computer device (CPU).

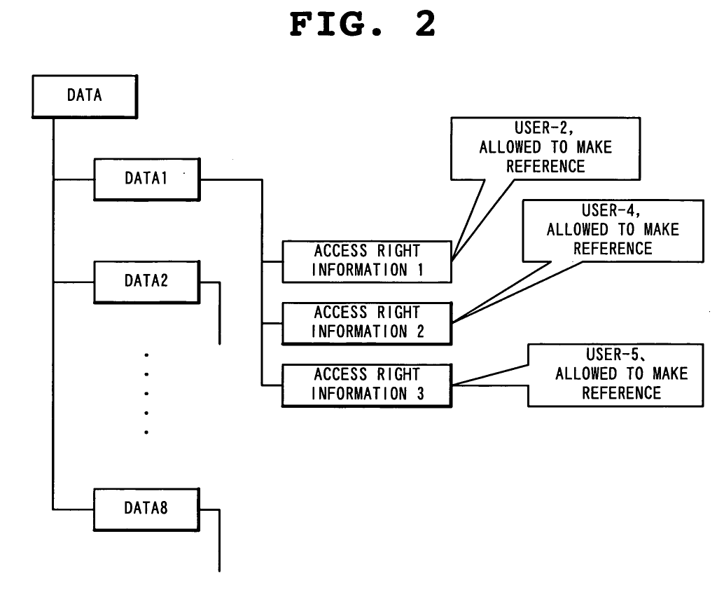

FIG. 2 shows data and its access right information to be stored in the data base 11. As illustrated in FIG. 2, to each of a plurality of pieces of data 1, . . . , data n, at least one access right information is applied (in FIG. 2, three pieces of access right information 1, 2 and 3 are applied to the data 1). Stored in the access right information are contents indicating to which user an access right of which contents (reference, update, etc.) is allowed.

The access right examination executing unit 20 collates a result returned by the search engine 12 and a result of the data base 11 and returns the collation result to the user.

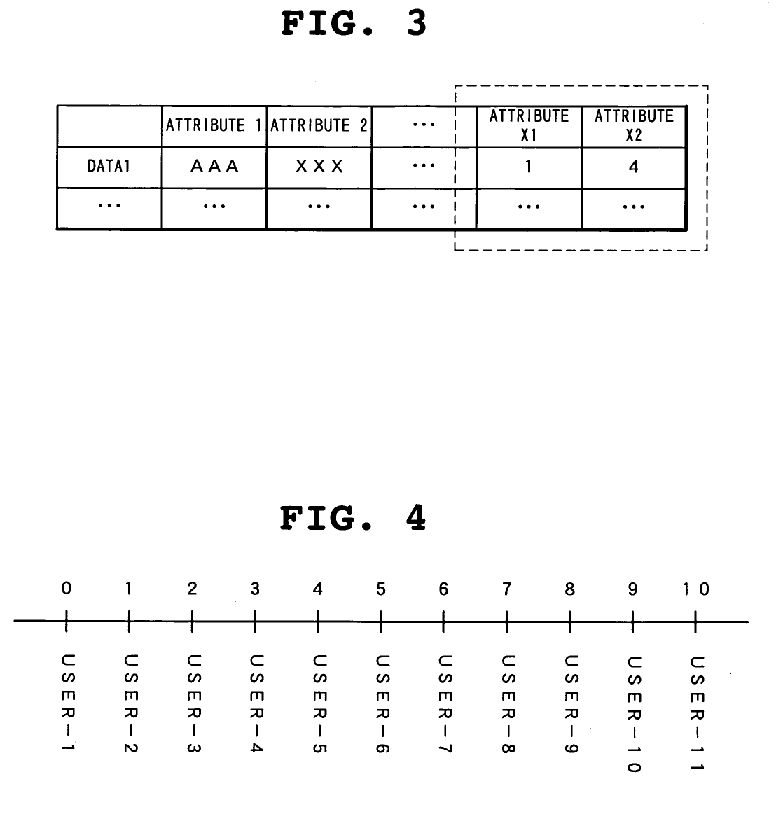

Furthermore, to a search key in the search engine 12, two access right information attributes X1 and X2 are added as an attribute for use as the search key as shown in FIG. 3.

The search engine 12 receives, as input, a retrieval condition with an attribute value set and returns, as output, data coincident with the input retrieval condition. When “attribute 1=AAA” is applied as input, as output, “data 1” shown in FIG. 3 is output.

The access right information attributes X1 and X2 are values determined at the time of data registration/update, which are set according to the contents of an access right applied to data.

In addition, by using data with values that the access right information attributes X1 and X2 can attain (0˜10 in FIG. 4) and users (USER-1˜USER-11) contained in the access right information aligned on a number line as shown in FIGS. 4, 5 and 7, obtain a range of an access right information attribute that a user indicated in access right information of each data can attain.

Operation of the retrieval system 10 according to the first embodiment will be described with reference to the drawings.

First, description will be made of a case of registering data in the data base 11 of the retrieval system 10.

(1) When registering data, receive data having such arrangement as shown in FIG. 2 from an operator. Assume here that the data 1 is received.

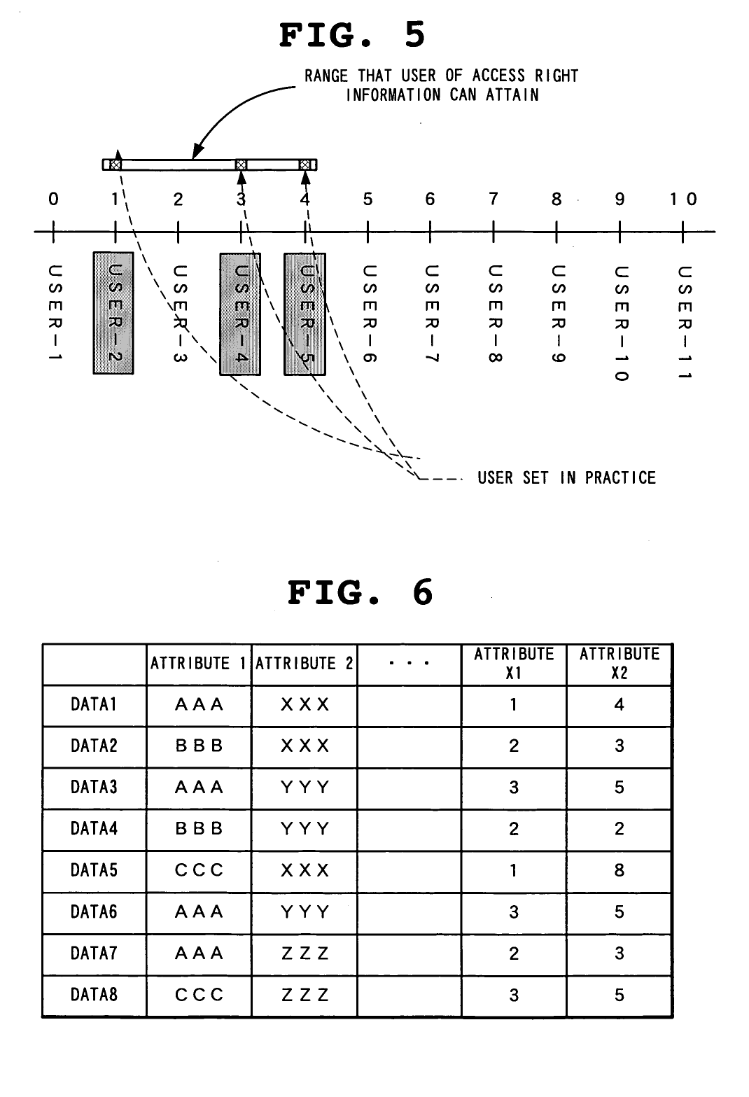

At this time, with the access right information 1 (USER-2 is allowed to make reference), the access right information 2 (USER-4 is allowed to make reference) and the access right information 3 (USER-5 is allowed to make reference) contained in the data 1, by arranging the access right information contained in the data 1 on such a number line as shown in FIG. 4, data is generated indicative of a range of the access right information attributes X1 and X2 that a user indicated in the access right information of the data 1 can attain and a user having a right to access the data as illustrated in FIG. 5.

Here, the corresponding parts of users to which the access right information 1, 2 and 3 are applied are painted out. In this case, shown is that a range of an access right information attribute that the users of the applied access right information can attain is not less than “1” and not more than “4”. In a case of the data 1 shown in FIG. 3, substitute the values “1” and “4” into the access right information attributes X1 and X2 as search key attributes of the data 1 to be registered.

(2) Next, register attributes of the data other than the access right information attributes at the data base 11.

(3) Furthermore, at the time of registering a search key at the search engine 12, register each attribute of data applied as input and the access right information attributes X1 and X2.

As to the other data (data 2 to data 8), the same processing (1)˜(3) is executed.

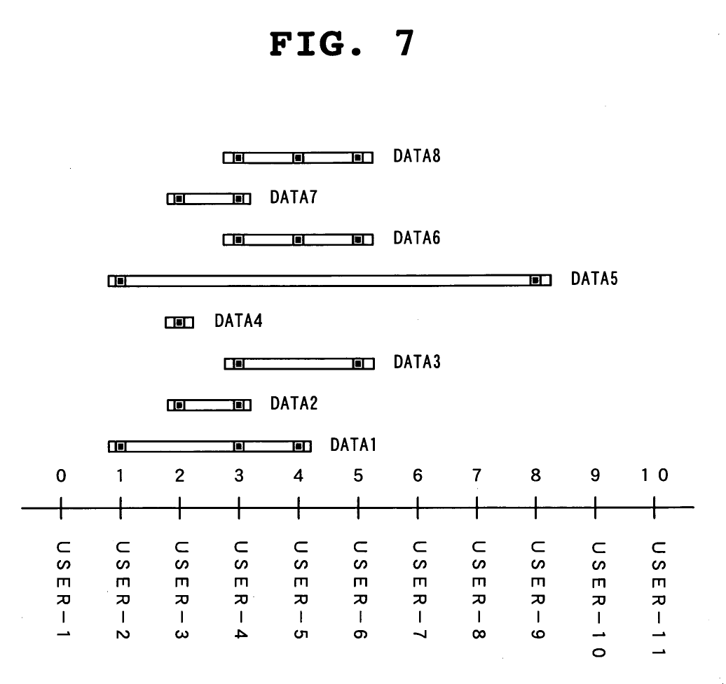

As a result, data having the access right information attributes X1 and X2 is registered at the data base 11 as shown in FIG. 6.

Next, retrieval processing by thus structured retrieval system 10 will be described with reference to the flow chart shown in FIG. 8.

Here, the description will be made of a case where a user (USER-3) retrieves data having the attribute 1=AAA (condition C1) from the data base 11.

Through the operator terminal 30 of an operator who makes retrieval, the user information (USER-3) indicative of the user's identification and the condition C1 are input to generate a retrieval condition C2 as shown in the following based on the application (Step 801):
attribute 1=AAA and attribute X1≦2 and attribute X2≧2

By executing retrieval by the search engine 12 according to the retrieval condition C2 generated at Step 801, obtain a retrieval result {data 1, data 7} (=R1) (Step 802).

Next, by examining information about a right to access the data indicated in the retrieval result R1 by means of the access right examination executing unit 20 (Step 803), obtain a result {data 7} (=R2) to which the user (USER-3) is allowed to refer.

Return the obtained result R2 {data 7} to the operator terminal 30 of the user (USER-3) (Step 804).

According to the retrieval system 10 of the first embodiment, the foregoing operation obtains the following effects.

First, access right examination processing in the retrieval system can be executed at a high speed. The reason is that the number of collations between a retrieval result of the search engine 12 and the data of the data base 11 can be reduced.

While in the above-described example, when the retrieval under the retrieval condition C2 is executed, the number of data returned from the search engine 12 is two, the number of data returned under the previous retrieval condition (condition C₁) including no access right information attribute as a condition is four.

In the examination of an access right, since processing is executed with respect to every result returned from the search engine 12, the less the number of retrieval results returned from the search engine 12, the shorter the processing time will become. With a common search engine, an increase in a retrieval processing time caused by complication of conditions is far smaller than time required for processing of access right examination.

More specifically, time T required for the processing of such a common search engine as shown in FIG. 1 will be expressed as follows. Here, Ts represents time required for retrieval processing by the search engine 12 and Ta represents time required for the processing of access right examination.
T=Ts+Ta

The present embodiment enables the time Ta required for access right examination processing to be reduced while barely increasing the retrieval processing time Ts, resulting in enabling reduction of a processing time required for the retrieval system.

On the other hand, although the access right information attribute needs to be added to the data base 11, the number of pieces of added information is as small as two to exert little effect on the entire retrieval system.

Secondly, while in a case where at the time of retrieval by the search engine, access right check is contained in a retrieval expression as is done in conventional processing, every access right information assigned to each data of the data base should be described and in a case where the number of access right information has a variable length, complicated data arrangement should be prepared for recording the information, thereby making the retrieval expression more complicated accordingly, the present embodiment only needs addition of an access right information attribute to each data, so that it is unnecessary to drastically change data arrangement in the data base 11.

In the present embodiment, data to be added (access right information attribute) is data indicative of a simple value whose number needs not be large, which enables a retrieval expression required at the time of retrieval by the search engine to have a simple structure.

### Second Embodiment

A retrieval system according to a second embodiment of the present invention will be described. Entire structure of the retrieval system according to the second embodiment is the same as that of the first embodiment shown in FIG. 1.

While the second embodiment is common to the first embodiment in that when a user makes retrieval from the retrieval system 10, out of results obtained by the search engine 12, only a result which can be returned to the user is returned, it is different from the first embodiment in that with respect to data with two kinds of access rights (access rights allowing the user to make reference or update), only one that can be returned to the user is returned.

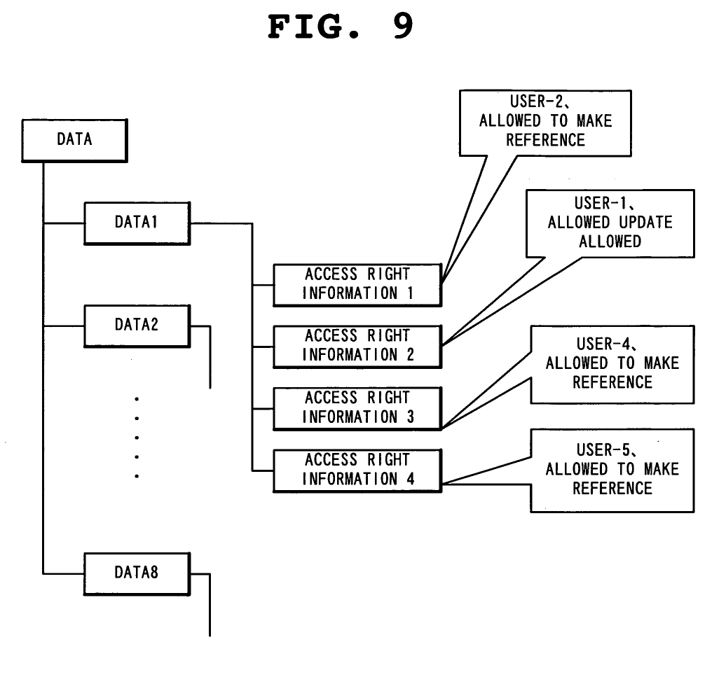

FIG. 9 shows arrangement of data to be stored in the data base 11 in the present embodiment. As shown in FIG. 9, a plurality of pieces of access right information (four access right information 1, 2, 3 and 4 in FIG. 9) are applied to the plurality of data 1, . . . , data n. In the access right information, contents indicating to which user an access right of which contents (reference, update, etc.) is allowed are stored, and in the case of FIG. 9, the information indicates that the users (USER-2, USER-4, USER-5) are allowed to make reference and the user (USER-2) is allowed to conduct updating. As to the user (USER-2), both reference and update are allowed.

The access right examination executing unit 20 returns to a user a result obtained by collating a retrieval result returned by the search engine 12 and a result of the data base 11.

Furthermore, to a search key in the search engine 12, four access right information attributes X1, X2, X3 and X4 are added as an attribute for use as a search key as shown in FIG. 10.

The access right information attributes X1, X2, X3 and X4 are values determined at the time of data registration/update, which are determined based on an access right applied to the data.

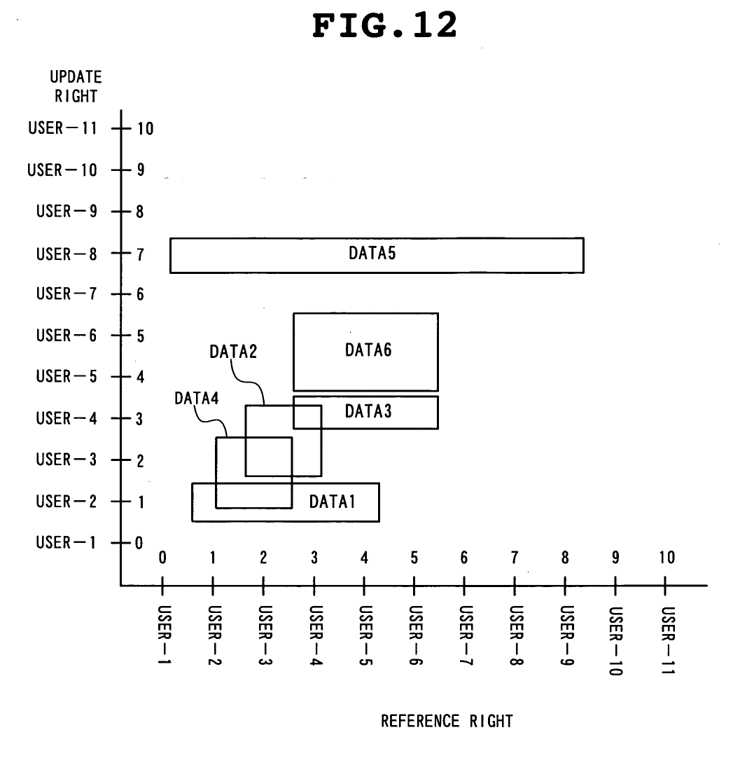

In addition, as shown in FIG. 12, obtain a range of an access right information attribute that a user indicated by access right information of each data can attain by using data with values (0˜10 in FIG. 12) that the access right information attributes X1 and X2 can attain and users included in access right information (reference right) allowing reference aligned on the abscissa and values (0˜10 in FIG. 12) that the access right information attributes X3 and X4 can attain and users included in access right information (update right) allowing update aligned on the ordinate.

Operation of the retrieval system 10 according to the second embodiment will be described with reference to the drawings.

First, the description will be made of a case where data is registered at the retrieval system 10.

(1) When registering data, receive data having such arrangement as shown in FIG. 9 from an operator. Assume here that the data 1 is received.

At this time, with the access right information 1 (USER-2 is allowed to make reference), the access right information 2 (USER-2 is allowed to make reference), the access right information 3 (USER-4 is allowed to make reference) and access right information 4 (USER-5 is allowed to make reference) contained in the data 1, by arranging the access right information contained in the data 1 on the secondary plane as shown in FIG. 12, data is generated which is indicative of a range of the access right information attributes X1, X2, X3 and X4 that a user indicated in the access right information of the data 1 can attain and a user having a right to access the data (the reference right and the update right).

Here, the corresponding parts of users to which the access right information 1, 2, 3 and 4 are applied are painted out. In this case, shown is that a range of users of the applied access right information can attain is not less than “1” and not more than “4”. Since in this case, among the applied access right information, the range of access right information attributes that a user having a reference right can attain is not less than “1” and not more than “4”, substitute the values “1” and “4” into the access right information attributes X1 and X2 as a search key of the data to be registered.

In addition, since among the applied access right information, the range of access right information attributes that a user having an update right can attain is not less than “1” and not more than “1” (i.e. only “1”), substitute the value “1” into the access right information attributes X3 and X4 as search key of the data to be registered.

(2) Next, register contents of the data other than the access right information attributes at the data base 11.

(3) Furthermore, at the time of registering a search key at the search engine 12, also register the access right information attributes X1, X2, X3 and X4 at data applied as input.

As to the other data (data 2 to data 6), the same processing (1)˜(3) is executed to substitute values into the access right information attributes X1, X2, X3 and X4.

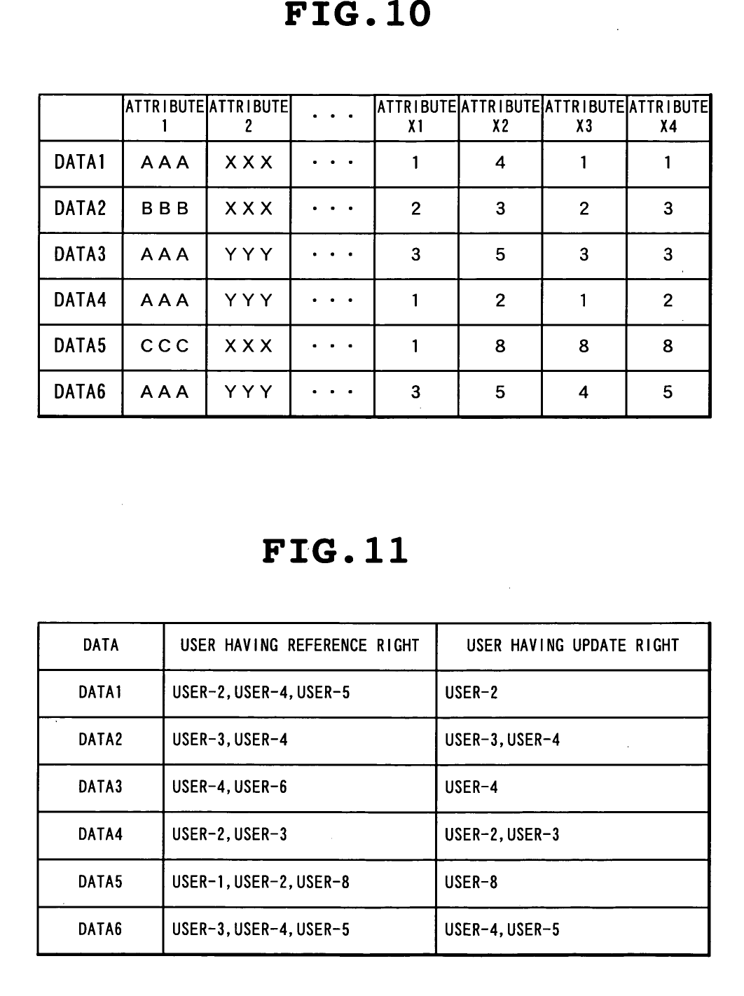

As a result, such data as shown in FIGS. 10 and 11 is registered at the data base 11. FIG. 11 shows a list of users having the reference right and the update right with respect to each data.

Next, retrieval processing by thus structured retrieval system 10 will be described with reference to the flow chart shown in FIG. 8.

Here, the description will be made of a case where the user (USER-2) retrieves data which satisfies the condition “attribute 1=AAA” (condition C1) and has the update right from the data base 11 shown in FIG. 10.

Through the operator terminal 30 of an operator who makes retrieval, the user information (USER-2) indicative of the user's identification and the condition C1 are input to generate a retrieval condition C2 as shown in the following based on the application (Step 801):
attribute 1=AAA and attribute X3≦1 and attribute X4≧1

By executing retrieval by the search engine 12 according to the retrieval condition C2 generated at Step 801, obtain a retrieval result {data 1, data 4} (=R1) (Step 802).

Next, by examining information about a right to access the data indicated in the retrieval result R1 by means of the access right examination executing unit 20 (Step 803), obtain a result {data 1, data 4} (=R2) which can be updated by the user (USER-2).

Return the obtained result R2 {data 1, data 4} to the operator terminal 30 of the user (USER-2) (Step 804).

On the other hand, when the user (USER-2) retrieves data which satisfies the condition “attribute 1=AAA” (condition C1) and has the reference right and the update right, the retrieval condition C2 set forth below is generated.
attribute 1=AAA and attribute X1≦1 and attribute X2≧1 and attribute X3≦1 and attribute X4

As a result of the retrieval made under the above-described condition C2 by the above-described procedure, {data 1, data 4} as the result R2 is returned to the user (USER-2) in this case.

Also by the second embodiment, the same effect as that obtained by the first embodiment can be attained.

### Third Embodiment

A retrieval system according to a third embodiment of the present invention will be described. Entire structure of the retrieval system according to the third embodiment is the same as that of the first embodiment shown in FIG. 1.

While the third embodiment is common to the first embodiment in that when a user makes retrieval from the retrieval system 10, out of results obtained by the search engine 12, only a result which can be returned to the user is returned, it is different from the first embodiment in that an access right is set not only to a user but also to an organization to which the user belongs, so that even when the user has no right to access data, if an organization (office) to which the user belongs has the access right, the user is allowed to refer to the data.

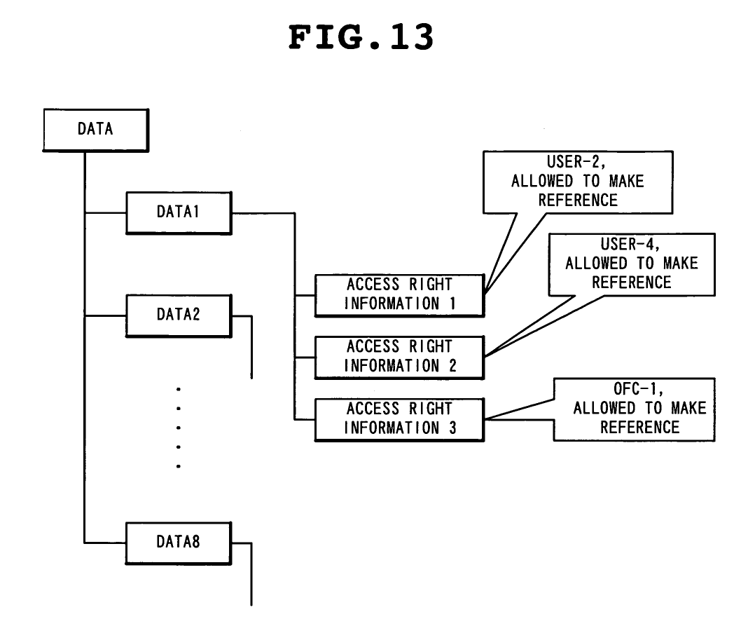

FIG. 13 shows arrangement of data to be stored in the data base 11 in the present embodiment. As shown in FIG. 13, a plurality of pieces of access right information (three access right information 1, 2 and 3 is applied to the data 1 in FIG. 13) are applied to the plurality of data 1, . . . , data n. In the access right information, contents indicating to which user an access right of which contents (reference, update, etc.) is allowed are stored, and in the case of FIG. 13, the information indicates that the users (USER-2, USER-4) are allowed to make reference and the office (OFC-1) is allowed to make reference.

Furthermore, to the search key in the search engine 12, two access right information attributes X1 and X2 are added as an attribute for use as a search key as shown in FIG. 14.

The access right information attributes X1 and X2 are values determined at the time of data registration/update, which are determined based on an access right applied to the data.

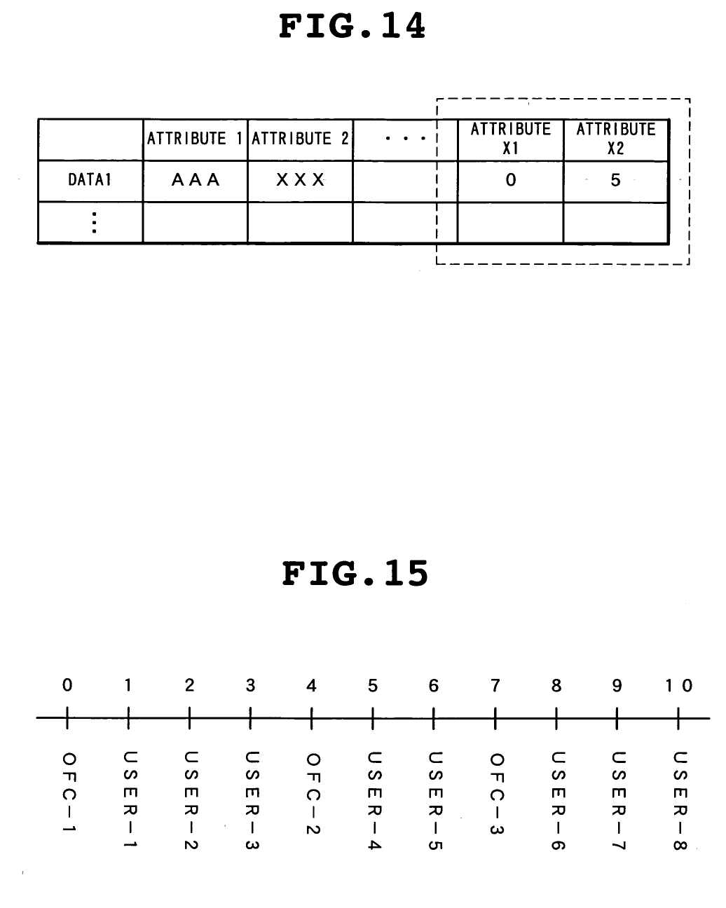

In addition, as shown in FIGS. 15, 16 and 19, by using data with values (0˜10 in FIG. 3) that the access right information attributes X1 and X2 can attain and users (USER-1˜USER-8) and offices (OFC-1˜OFC-3) included in access right information aligned on the number line, obtain a range of an access right information attribute that a user and an office indicated by access right information of each data can attain.

Here, a user belonging to a specific office is arranged to the right of the office on the number line. For example, the users (USER-1, USER-2, USER-3) belonging to the office (OFC-1) are arranged to the right of the office (OFC-1).

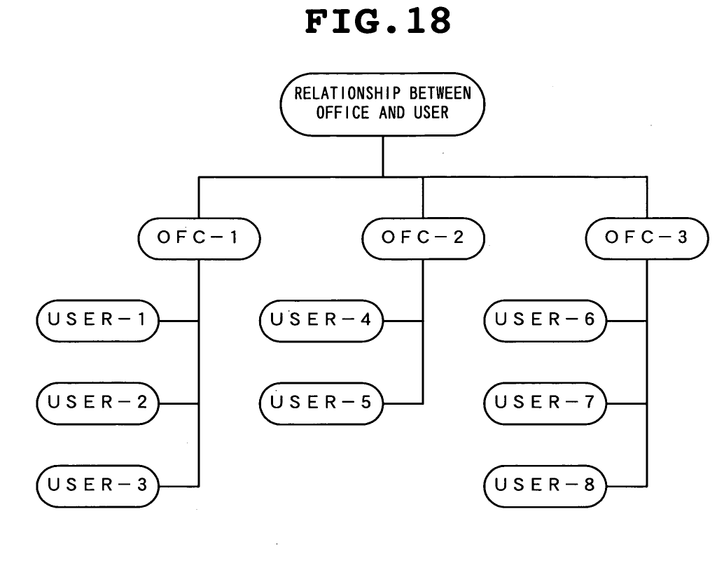

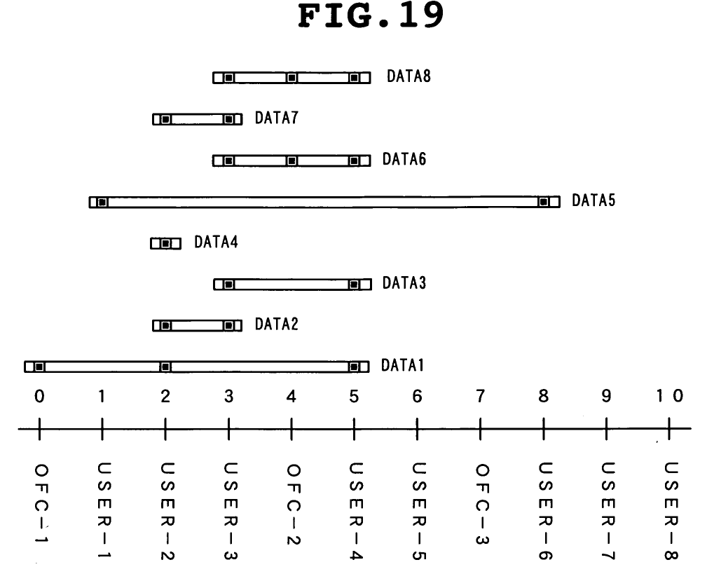

FIG. 18 shows a relationship between each office (OFC-1˜OFC3) and a user (USER-1˜USER-8) belonging to the office.

Operation of the retrieval system 10 according to the third embodiment will be described with reference to the drawings.

First, the description will be made of a case where data is registered at the retrieval system 10.

(1) When registering data, receive data having such arrangement as shown in FIG. 13 from an operator. Assume here that the data 1 is received.

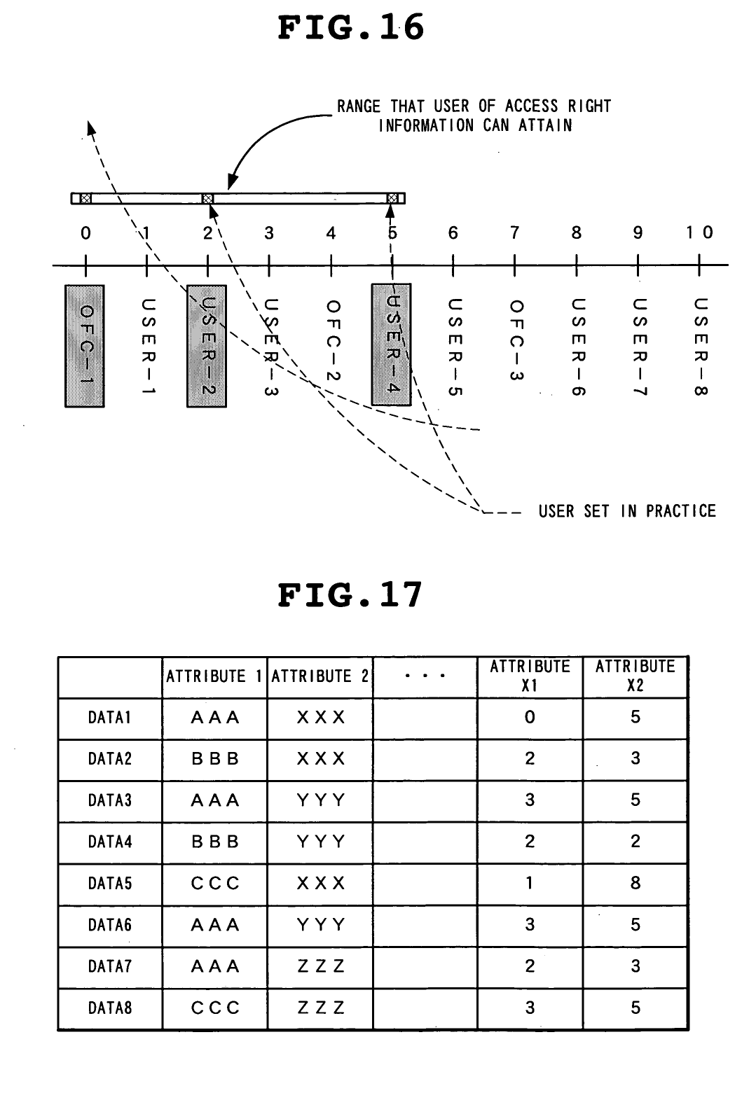

At this time, with the access right information 1 (USER-2 is allowed to make reference), the access right information 2 (USER-4 is allowed to make reference) and the access right information 3 (OFC-1 is allowed to make reference) contained in the data 1, by arranging the access right information contained in the data 1 on the number line as shown in FIG. 15, data is generated indicative of a range of the access right information attributes X1 and X2 that a user and an office indicated in the access right information of the data 1 can attain and a user and an office having a right to access the data as shown in FIG. 16.

Here, the corresponding parts of users and offices to which the access right information 1, 2 and 3 are applied are painted out. Since in this case, the range that an user and an office of the applied access right information can attain is not less than “0” and not more than “5”, substitute “0” and “5” into the access right information attributes X1 and X2 as search key attributes of the data 1 (see “data 1” in FIG. 14).

(2) Next, register contents of the data other than the access right information attributes at the data base 11.

(3) Furthermore, at the time of registering a search key at the search engine 12, also register the access right information attributes X1 and X2 at data applied as input.

As to the other data (data 2 to data 8), the same processing (1)˜(3) is executed to substitute values into the access right information attributes X1 and X2.

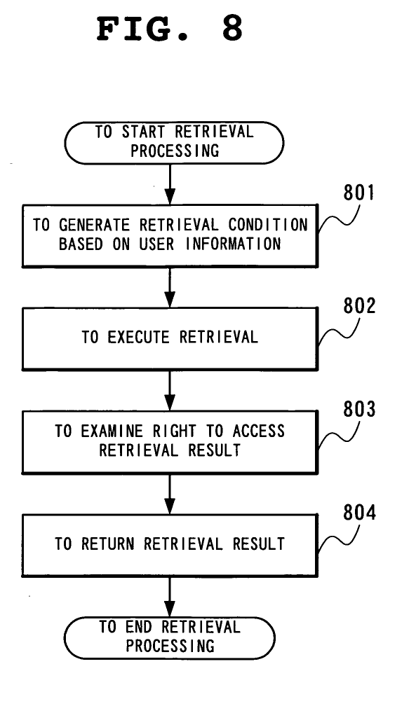

As a result, such data as shown in FIG. 6 is registered at the data base 11 to obtain such a number line as shown in FIG. 7.

Next, retrieval processing by thus structured retrieval system 10 will be described with reference to the flow chart shown in FIG. 8.

Here, the description will be made of a case where the user (USER-3) retrieves data having the “attribute 1=AAA” (condition C1) from the data base 11. As illustrated in FIG. 18, the user (USER-3) belongs to the office (OFC-1).

Through the operator terminal 30 of an operator who makes retrieval, the user information (USER-3) indicative of the user's identification and the condition C1 are input to generate the retrieval condition C2 as shown in the following based on the application (Step 801):
attribute 1=AAA and attribute X1≦0 and attribute X2≧3

By executing retrieval by the search engine 12 according to the retrieval condition C2 generated at Step 801, obtain a retrieval result {data 1, data 7} (=R₁) (Step 802).

Next, by examining information about a right to access the data indicated in the retrieval result R1 by means of the access right examination executing unit 20 (Step 803), obtain a result {data 1, data 7} (=R2) which can be referred to by the user (USER-3).

Return the obtained result R2 {data 1, data 7} to the operator terminal 30 of the user (USER-3) (Step 804).

Also by the third embodiment, the same effect as that obtained by the first embodiment can be attained.

Although the present invention has been described with respect to the plurality of embodiments in the foregoing, the present invention is not necessarily limited to the above-described embodiments and can be embodied in various forms within the range of its technical ideas.

According to the data retrieval system according to the present invention, the following effects can be attained.

First, processing of examining an access right in the retrieval system can be executed at a high speed. The reason is that the number of retrieval results obtained by a search engine with respect to which access right examination processing should be executed can be reduced.

The present invention is in particular effective when an access right examination processing time is longer than a processing time required for retrieval.

Secondly, since only an access right information attribute is added to each data, speed-up of processing for examining an access right can be realized without largely changing data arrangement of a data base. According to the present invention, data (access right information attribute) to be added is data indicative of a simple value whose number needs not be large, which enables a retrieval expression necessary at the time of retrieval by the search engine to have a simple structure.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A data retrieval system which retrieves data of a data base according to a search key entered by a user by means of a search engine to return a retrieval result to said user, wherein
an access right attribute value indicative of a range of an access right of said user is set to data of said data base, and
the search key to be registered at said search engine is designed to enable designation of said access right attribute value.

2. The data retrieval system as set forth in claim 1, wherein
at the time of registering data at said data base, an access right attribute value indicative of a range of an access right of said user is set to said data and said access right attribute value is registered at the search key to be registered at said search engine, and
said search key is enabled to designate said access right attribute value at the time of retrieval of said data base.

3. The data retrieval system as set forth in claim 1, wherein
to said access right attribute value, a value is set for each user having said access right.

4. The data retrieval system as set forth in claim 1, wherein
at the time of registering data at said data base, an access right attribute value indicative of a range of an access right of said user is set to said data and said access right attribute value is registered at the search key to be registered at said search engine,
said search key is enabled to designate said access right attribute value at the time of retrieval of said data base, and
to said access right attribute value, a value is set for each user having said access right.

5. The data retrieval system as set forth in claim 1, wherein
to said access right attribute value, a value is set for each user having said access right, and
out of said access rights to which said data is applied, two of said access right attribute value which is the smallest and said access right attribute value which is the largest are set to the data of said data base.

6. The data retrieval system as set forth in claim 1, wherein
at the time of registering data at said data base, an access right attribute value indicative of a range of an access right of said user is set to said data and said access right attribute value is registered at the search key to be registered at said search engine,
said search key is enabled to designate said access right attribute value at the time of retrieval of said data base,
to said access right attribute value, a value is set for each user having said access right, and out of said access rights to which said data is applied, two of said access right attribute value which is the smallest and said access right attribute value which is the largest are set to the data of said data base.

7. The data retrieval system as set forth in claim 1, wherein
to each kind of said access right, an access right attribute value indicative of a range of said access right is set.

8. The data retrieval system as set forth in claim 1, wherein
at the time of registering data at said data base, an access right attribute value indicative of a range of an access right of said user is set to said data and said access right attribute value is registered at the search key to be registered at said search engine,
said search key is enabled to designate said access right attribute value at the time of retrieval of said data base, and
to each kind of said access right, an access right attribute value indicative of a range of said access right is set.

9. The data retrieval system as set forth in claim 7, wherein
said access right includes a reference right which allows reference to data and an update right which allows update of data and to each of said reference right and said update right, an access right attribute value indicative of a range of said access right is set.

10. The data retrieval system as set forth in claim 1, wherein
said access right attribute value is set with respect to an access right of said user and an access right of an office to which said user belongs such that said access right attribute value corresponding to the access right of said office is smaller than said access right attribute value corresponding to the access right of said user.

11. The data retrieval system as set forth in claim 1, wherein
at the time of registering data at said data base, an access right attribute value indicative of a range of an access right of said user is set to said data and said access right attribute value is registered at the search key to be registered at said search engine,
said search key is enabled to designate said access right attribute value at the time of retrieval of said data base, and
said access right attribute value is set with respect to an access right of said user and an access right of an office to which said user belongs such that said access right attribute value corresponding to the access right of said office is smaller than said access right attribute value corresponding to the access right of said user.

12. A data retrieval method in a data retrieval system of retrieving data of a data base according to a search key entered by a user by means of a search engine to return a retrieval result to said user, comprising the steps of:
setting an access right attribute value indicative of a range of an access right of said user to data of said data base, and
designating said access right attribute value to the search key to be registered at said search engine to make retrieval.

13. The data retrieval method as set forth in claim 12, wherein
at the time of registering data at said data base, an access right attribute value indicative of a range of an access right of said user is set to said data and said access right attribute value is registered at the search key to be registered at said search engine, and
at the time of retrieval of said data base, said access right attribute value is designated to said search key to make retrieval.

14. The data retrieval method as set forth in claim 12, wherein
as said access right attribute value, a value is set for each user having said access right.

15. The data retrieval method as set forth in claim 12, wherein
at the time of registering data at said data base, an access right attribute value indicative of a range of an access right of said user is set to said data and said access right attribute value is registered at the search key to be registered at said search engine,
as said access right attribute value, a value is set for each user having said access right, and
at the time of retrieval of said data base, said access right attribute value is designated to said search key to make retrieval.

16. The data retrieval method as set forth in claim 14, wherein
out of said access right to which said data is applied, two of said access right attribute value which is the smallest and said access right attribute value which is the largest are set to the data of said data base.

17. The data retrieval method as set forth in claim 12, wherein
to each kind of said access right, an access right attribute value indicative of a range of said access right is set.

18. The data retrieval method as set forth in claim 17, wherein
said access right includes a reference right which allows reference to data and an update right which allows update of data and to each of said reference right and said update right, an access right attribute value indicative of a range of said access right is set.

19. The data retrieval method as set forth in claim 12, wherein
said access right attribute value is set with respect to an access right of said user and an access right of an office to which said user belongs such that said access right attribute value corresponding to the access right of said office is smaller than said access right attribute value corresponding to the access right of said user.

20. A data retrieval program in a data retrieval system which retrieves data of a data base according to a search key entered by a user by means of a search engine to return a retrieval result to said user, comprising the functions of:
setting an access right attribute value indicative of a range of an access right of said user to data of said data base, and
designating said access right attribute value to the search key to be registered at said search engine to make retrieval.

21. The data retrieval program as set forth in claim 20, wherein
at the time of registering data at said data base, an access right attribute value indicative of a range of an access right of said user is set to said data and said access right attribute value is registered at the search key to be registered at said search engine, and
at the time of retrieval of said data base, said access right attribute value is designated to said search key to make retrieval.

22. The data retrieval program as set forth in claim 20, wherein
as said access right attribute value, a value is set for each user having said access right.

23. The data retrieval program as set forth in claim 20, wherein
at the time of registering data at said data base, an access right attribute value indicative of a range of an access right of said user is set to said data and said access right attribute value is registered at the search key to be registered at said search engine,
as said access right attribute value, a value is set for each user having said access right, and
at the time of retrieval of said data base, said access right attribute value is designated to said search key to make retrieval.

24. The data retrieval program as set forth in claim 22, wherein
out of said access right to which said data is applied, two of said access right attribute value which is the smallest and said access right attribute value which is the largest are set to the data of said data base.

25. The data retrieval program as set forth in claim 20, wherein
to each kind of said access right, an access right attribute value indicative of a range of said access right is set.

26. The data retrieval program as set forth in claim 25, wherein
said access right includes a reference right which allows reference to data and an update right which allows update of data and to each of said reference right and said update right, an access right attribute value indicative of a range of said access right is set.

27. The data retrieval program as set forth in claim 20, wherein
said access right attribute value is set with respect to an access right of said user and an access right of an office to which said user belongs such that said access right attribute value corresponding to the access right of said office is smaller than said access right attribute value corresponding to the access right of said user.
